(19) United States
(12) Patent Application Publication
(10) Pub. No.: US 2025/0132873 A1
(43) Pub. Date: Apr. 24, 2025

(54) USER EQUIPMENT ASSISTED RELAY OF INFORMATION FROM BACKSCATTERED SIGNAL

(71) Applicant: QUALCOMM Incorporated, San Diego, CA (US)

(72) Inventors: Raviteja PATCHAVA, San Diego, CA (US); Piyush GUPTA, Bridgewater, NJ (US)

(21) Appl. No.: 18/491,439

(22) Filed: Oct. 20, 2023

(51) Int. Cl. H04L 5/00

(52) U.S. Cl. CPC H04L 5/0048; H04L 5/006

(57) ABSTRACT

Certain aspects of the present disclosure provide techniques for wireless communications by an apparatus. A method includes transmitting, to a user equipment (UE), an indication of a first frequency of a first signal and an indication of a second frequency of a backscattered signal corresponding to the first signal; transmitting the first signal; and receiving, from the UE, information encoded in the backscattered signal.

### INTRODUCTION

### Field of the Disclosure

Aspects of the present disclosure relate to wireless communications, and more particularly, to techniques for communication with devices with passive radio equipment.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus. The method includes transmitting, to a user equipment (UE), an indication of a first frequency of a first signal and an indication of a second frequency of a backscattered signal corresponding to the first signal; transmitting the first signal; and receiving, from the UE, information encoded in the backscattered signal.

Another aspect provides a method for wireless communications by an apparatus. The method includes receiving, from a UE, an indication of a first frequency of a first signal and an indication of a second frequency of a backscattered signal corresponding to the first signal; receiving the backscattered signal; and transmitting, to the UE, information encoded in the backscattered signal.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 further depicts an example wireless communications device.

FIG. 6 depicts a process flow for communications in a network between a transmit (Tx) UE, a receive (Rx) UE, and a backscattering device.

FIG. 7 depicts a process flow for communications in a network between a Tx UE, one or more Rx UEs, and a backscattering device.

FIG. 8 depicts a method for wireless communications.

FIG. 9 depicts another method for wireless communications.

FIG. 10 depicts aspects of an example communications device.

FIG. 11 depicts aspects of an example communications device.

### DETAILED DESCRIPTION

Aspects of the present disclosure provide apparatuses, methods, processing systems, and computer-readable mediums for user equipment (UE) assisted relay of information from a backscattered signal. In particular, certain aspects provide techniques for a first UE to communicate with a lower power device that uses passive radio equipment, such as an ambient Internet of Things (AIoT) device, via a second UE. Though certain aspects are discussed herein with respect to communicating with an AIoT device, it should be noted that the techniques discussed herein may be used for communicating with any suitable device having passive radio equipment (also referred to as a backscattering device or backscattering wireless communications device).

AIoT devices typically have low complexity designs configured to use low power for communicating (e.g., transmitting and/or receiving) wireless signals. For example, AIoT devices may generally have limited energy storage capabilities, such as limited storage batteries or a capacitor or other short term energy storage device. In some cases, AIoT devices rely on energy harvesting from one or more external sources. The one or more external sources may include: solar energy, thermal energy, kinetic energy, radio frequency (RF) energy, electromagnetic radiation (EMR), other types of ambient energy, and the like. For example, an AIoT device may include one or more components that allow the AIoT device to harvest energy, such as solar cells, RF power converters, and the like. Example AIoT devices include tags, such as radio frequency identification (RFID) tags, passive UEs, backscattering UEs, and the like.

An AIoT device may not include active RF components, and instead may use passive radio equipment (e.g., a backscatter-type radio) for communicating. For example, AIoT devices are generally capable of asynchronous communication and may not have a power amplifier or a low-noise amplifier. AIoT UEs may generally utilize a light protocol stack.

In certain aspects, an AIoT device, using passive radio equipment, is configured to modulate and reflect incident RF signals (e.g., a carrier wave (CW)). For example, another device (e.g., UE) may transmit a CW in the direction of the AIoT device. The AIoT device, using the passive radio equipment, modulates and reflects the CW to communicate data. The modulated and reflected CW may be referred to as a backscattered signal, where information is encoded in the backscattered signal based on the modulation.

A technical problem arises when a UE directly communicates with an AIoT device using passive radio equipment. In particular, the time difference between the transmission of the CW by the UE and arrival of the backscattered signal at the UE may be small due to proximity of the UE and the AIoT device, such that the transmission of the CW by the UE may overlap in time with arrival of the backscattered signal at the UE. Accordingly, the UE may need to be capable of full-duplex communications (e.g., transmission and reception of signals simultaneously) to both transmit the CW and receive the backscattered signal, which may add to complexity and cost of the UE, such as compared to a UE that is capable only of half-duplex communications (e.g., only one of transmission or reception of signals at a time).

Further, when modulating and reflecting the CW, the AIoT device may apply a frequency shift to the backscattered signal, such that the CW and the backscattered signal do not occupy the exact same frequency. However, the frequency shift applied by the AIoT device may be small. Accordingly, the CW and the backscattered signal may be close in frequency, such that, even for a full-duplex UE, the transmission of the CW by the UE, especially due to its signal strength as it is transmitted by the UE, may interfere with reception of the backscattered signal. This may require the full-duplex UE to have higher complexity filters and/or other signal processors to receive the backscattered signal.

In some cases, an AIoT device may be configured to apply a larger frequency shift, such that the UE can separate the CW and the backscattered signal in frequency, even though the CW signal strength is strong at the UE. However, this may lead to complexity increases in the AIoT device to implement circuits capable of applying a larger frequency shift, and may still require the UE to support full-duplex communications, which may increase complexity and costs of the UE.

Accordingly, certain aspects discussed herein provide techniques for a first UE to communicate with a second UE to communicate with an AIoT device. For example, a first UE, referred to as a transmit (Tx) UE may be configured to identify a second UE, referred to as a receive (Rx) UE to relay information contained in the backscattered signal to the Tx UE. The Tx UE may transit a CW to the AIoT device, which modulates and reflects the CW as a backscattered signal encoded with information. The Rx UE may receive the backscattered signal, and then transmit the information encoded in the backscattered signal to the Tx UE, such as on a sidelink channel using device to device communications. Such techniques may provide a beneficial technical effect, in that the Tx UE and/or Rx UE may not require use of full-duplex communications, and further the AIoT device may not require to be able to apply a large frequency shift. In particular, even UEs and AIoT devices with lower complexity are then able to communicate, with reduced interference. For example, to receive the CW and the backscattered signal, the Rx UE may only need to be capable of half-duplex communications. Further, as the signal strength of the CW as received at the Rx UE may be much lower than as received at the Tx UE, the Rx UE may not require higher complexity filters and/or other signal processors to receive the backscattered signal.

Additionally, in certain aspects, the frequency shift applied to the CW and the frequency of the CW are selected such that the CW and the backscattered signal occupy frequency resources used for sidelink communications (referred to as sidelink resources). As such sidelink resources may already be reserved for sidelink communications, the CW and backscattered signal are less likely to interfere with other communications devices, providing the beneficial technical effect of reduced interference.

Certain aspects further provide techniques for the Tx UE to utilize the AIoT device to help identify a suitable UE to act as the Rx UE, such as among one or more UEs. For example, the Tx UE may independently be able to select a UE of the one or more UEs to act as an Rx UE based on a proximity between the Tx UE and the UE (e.g., based on reference signal measurements). However, proximity of a UE to the Tx UE may not always be a good indicator of a good Rx UE, as such a UE may not be close enough to the AIoT device to adequately receive and decode the backscattered signal, causing a technical problem in how to identify an Rx UE.

Accordingly, certain aspects discussed herein provide techniques for the Tx UE to utilize the AIoT device to help identify a suitable UE to act as the Rx UE, which may improve communications reliability between the Rx UE and the AIoT device. For example, the Tx UE may transmit a reference signal (RS). The AIoT device may modulate and reflect the RS as a backscattered RS. One or more UEs (also referred to as candidate Rx UEs) may receive the backscattered RS (and in some cases the RS). Each of the one or more UEs may report its respective measurement of the backscattered RS (and in some cases its respective measurement of the RS) to the Tx UE, such that the Tx UE can utilize the measurements of the backscattered RS (and in some cases also the measurements of the RS) to identify a suitable UE of the one or more UEs to act as the Rx UE. The measurements of the backscattered RS provide an indication of channel quality (also referred to as signal quality) between each of the one or more UEs and the AIoT device, while the measurements of the RS provide an indication of channel quality between each of the one or more UEs and the Tx UE. The Tx UE, therefore, may select a UE with adequate channel quality between the AIoT device and the UE to act as the Rx UE, which may provide the beneficial technical effect of improved communications reliability between the Rx UE and the AIoT device.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

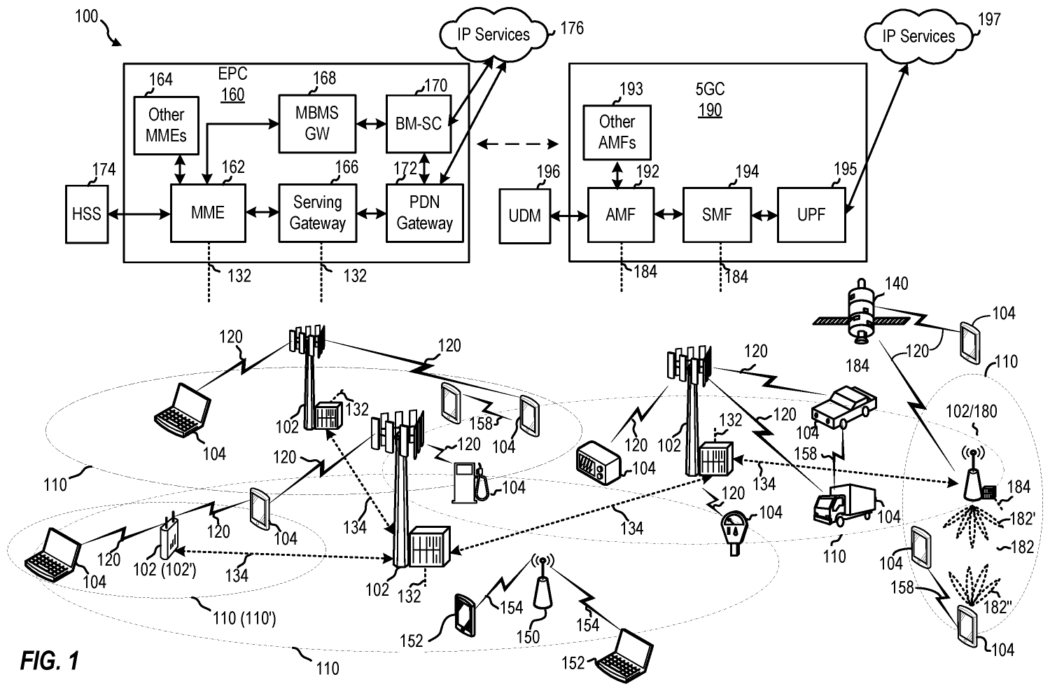

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and transporter, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

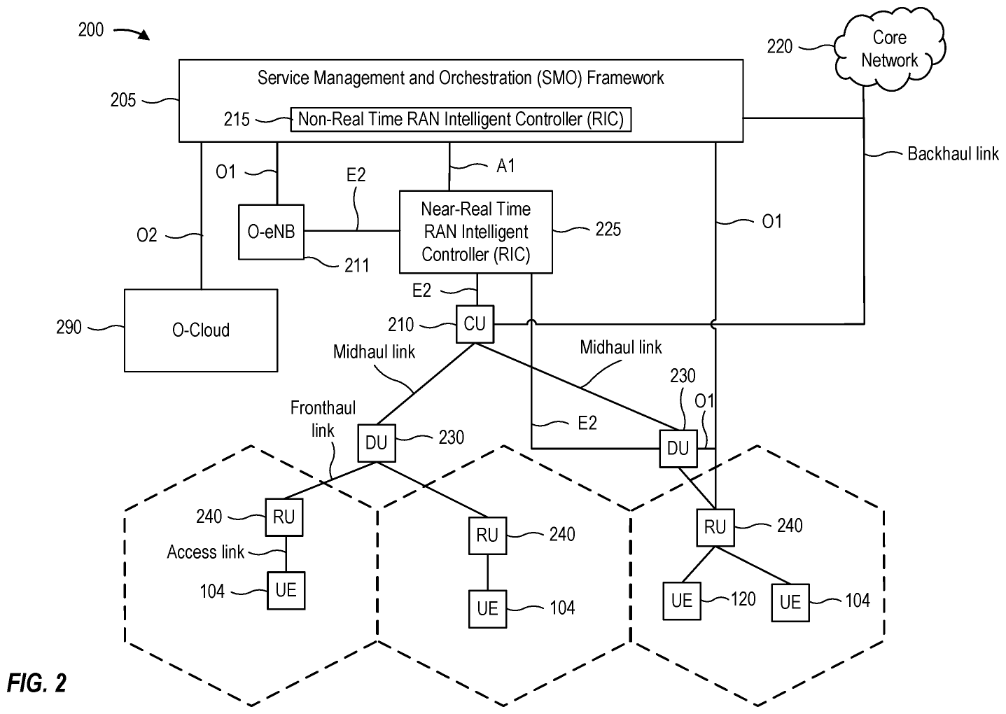

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an AI interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as AI policies).

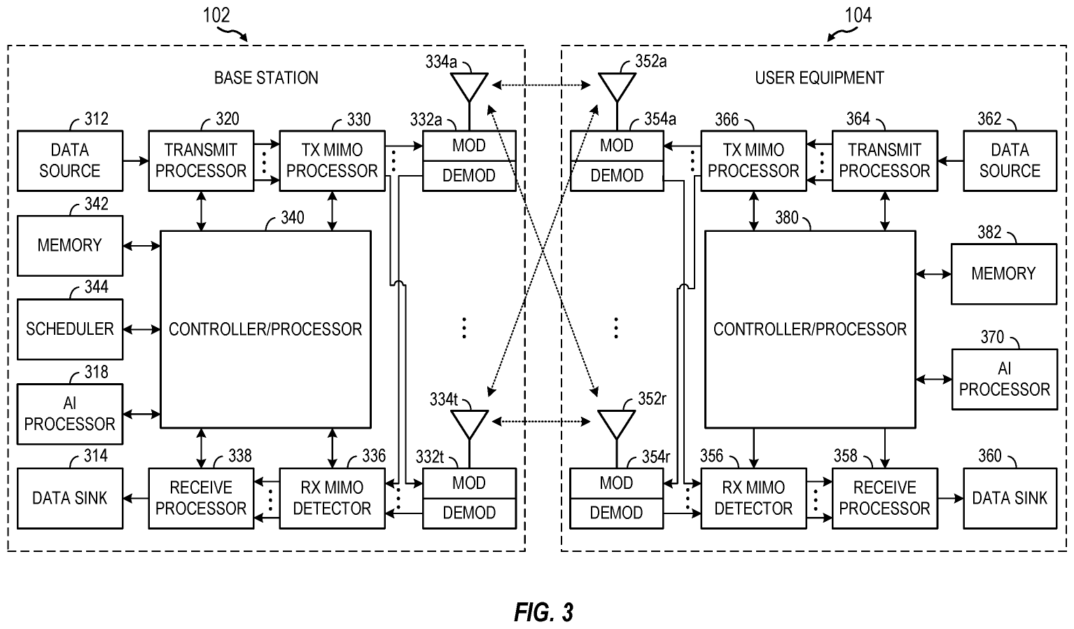

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., global navigation satellite system (GNSS) positioning). In some cases, the AI processor 318 may process feedback from the UE 104 (e.g., CSF) using hardware accelerated AI inferences and/or Altraining. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

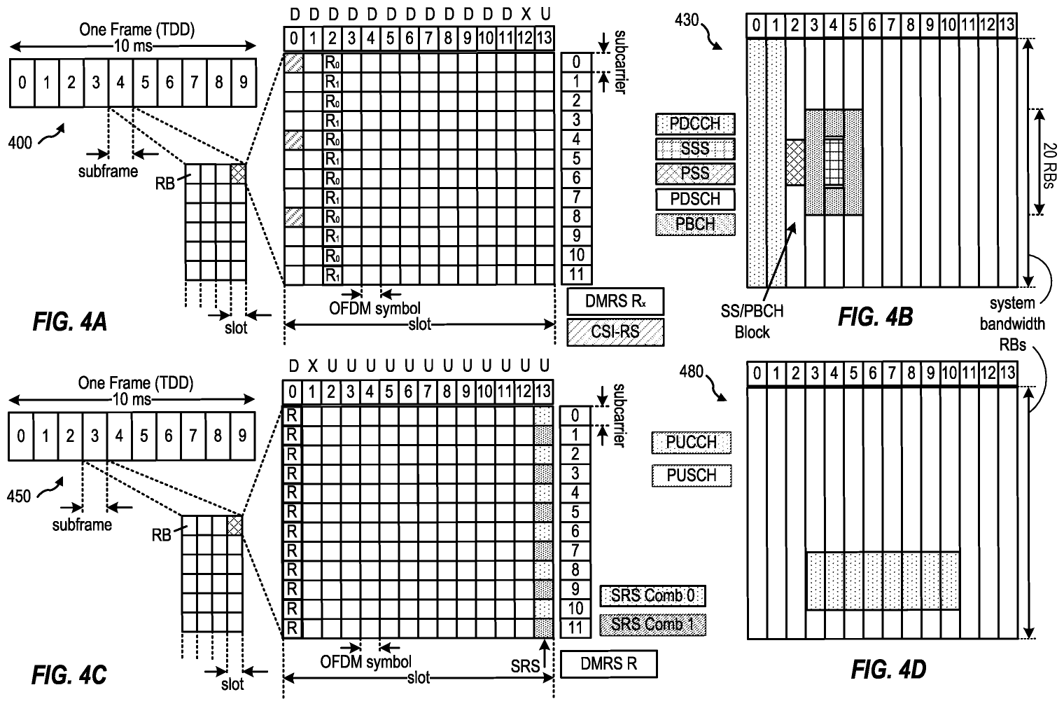

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5GNNR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 2 slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2×15 kHz, where is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 s.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Backscattering

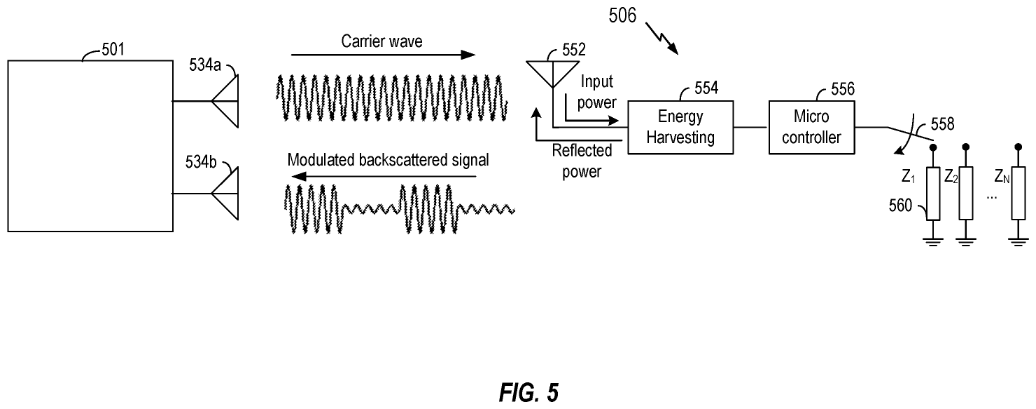

FIG. 5 depicts an example backscattering wireless communications device 506. The backscattering wireless communications device 506 may be an AIoT device, a UE (e.g., similar to UE 104 of FIG. 1), or the like.

As shown, backscattering wireless communications device 506 includes an antenna 552, an energy harvesting (EH) circuit 554, a microcontroller 556, a switch 558, and impedance circuits 560. In other aspects, backscattering wireless communications device 506 may include additional components (e.g., a battery or capacitor), or fewer components (e.g., removal of EH circuit 554).

Antenna 552 may be similar to antenna 352a of FIG. 3. Antenna 552 is coupled to EH circuit 554. EH circuit 554 may include one or more power converters and/or the like for receiving (e.g, RF) energy and converting it into usable energy for backscattering wireless communications device 506. EH circuit 554 is further coupled to microcontroller 556. In other aspects, microcontroller 556 may be directly coupled to antenna 552.

Microcontroller 556 is coupled to switch 558 and configured to control switch 558 to selectively couple impedance circuits 560 to the circuit including antenna 552. Impedance circuits 560 may be any components that provide impedance.

FIG. 5 further depicts a wireless communications device 501, such as a UE (e.g., UE 104 of FIG. 1). Wireless communications device 501 further includes antennas 534a and 534b, which may be similar to antennas 334a and 334b of FIG. 3.

In certain aspects, wireless communications device 501 is configured to transmit a carrier wave from antenna 534a. A carrier wave is a waveform (e.g., sinusoidal waveform) that can be modulated with data (e.g., an information-bearing signal) to generate a modulated signal that conveys the data.

In certain aspects, backscattering wireless communications device 506 is configured to receive the carrier wave, transmitted by wireless communications device 501, at antenna 552. Backscattering wireless communications device 506 modulates the carrier wave be switching the switch 558 to vary the impedance coupled to the antenna 552. In particular, the switch 558 varies the impedance by switching a number or size of impedance circuits 560 coupled to antenna 552. Varying the impedance coupled to the antenna 552 varies an amplitude and/or phase of the carrier wave. For example, when the antenna 552 is coupled to a high impedance, the mismatch between the antenna and load impedance reflects all the power received on antenna 552 back. When the antenna 552 is coupled to an impedance matched to an impedance of the antenna, the match between the antenna and load impedances causes the power to be absorbed at backscattering wireless communications device 506 and little power is reflected on antenna 552. Therefore, switching between a high impedance and matched impedance modulates an amplitude of the carrier wave reflected. The frequency of switching between the impedances may be associated with a data rate of communicating data.

Accordingly, the microcontroller 556 controls the switch 558 to modulate the carrier wave with data, to generate a modulated backscattered signal. For example, microcontroller 556 controls the switch 558 to perform amplitude-shift keying (ASK) modulation to vary the amplitude of the carrier wave and or phase-shift keying (PSK) modulation to vary the phase of the carrier wave. Backscattering wireless communications device 506 transmits (e.g., reflects) the modulated backscattered signal via antenna 552.

In certain aspects, wireless communications device 501 is configured to receive the modulated backscattered signal on antenna 534b. The wireless communications device 501 may process the modulated backscattered signal to decode the data transmitted by backscattering wireless communications device 506.

Aspects Related to UE Assisted Relay of Information from a Backscattered Signal

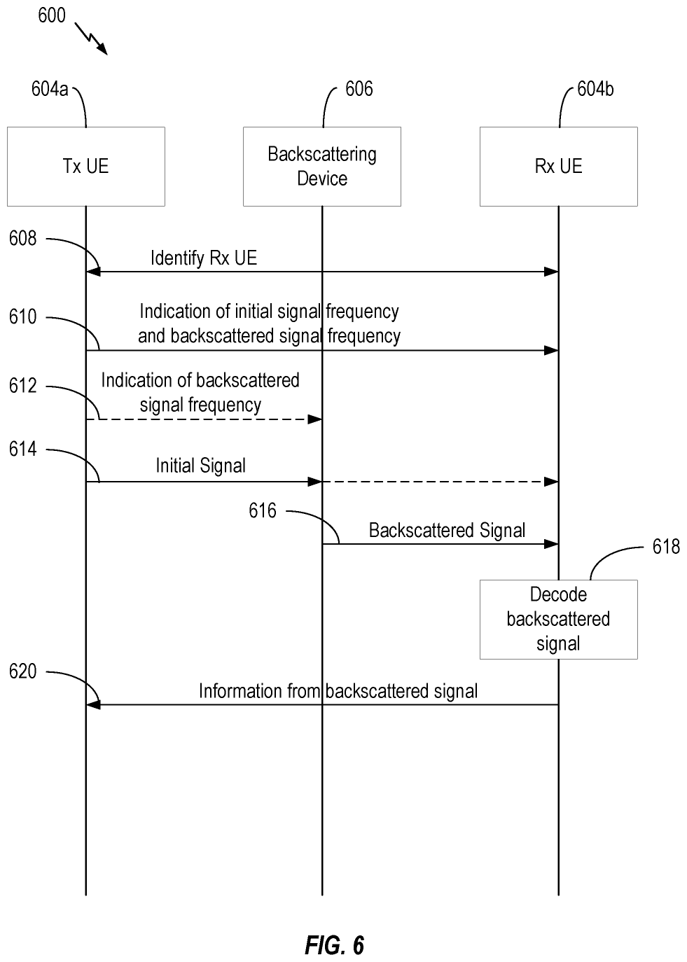

As discussed, a technical problem arises when a UE directly communicates with an AIoT device using passive radio equipment. In particular, the transmission of a CW by the UE may interfere with reception of the backscattered signal. Accordingly, certain aspects discussed herein provide techniques for a Tx UE to communicate with an Rx UE in order to communicate with a backscattering device. An example of such a technique is discussed with respect to FIG. 6.

FIG. 6 depicts a process flow 600 for communications in a network between a Tx UE 604a, an Rx UE 604b, and a backscattering device 606 (such as an AIoT device). In some aspects, each of the Tx UE 604a and/or Rx UE 604b may be an example of UE 104 depicted and described with respect to FIGS. 1 and 3. However, in other aspects, each of the Tx UE 604a and/or Rx UE 604b may be another type of wireless communications device, such as those described herein. Backscattering device 606 may be an example of backscattering wireless communications device 506 depicted and described with respect to FIG. 5. However, in other aspects, backscattering device 606 may be another type of wireless communications device, such as those described herein.

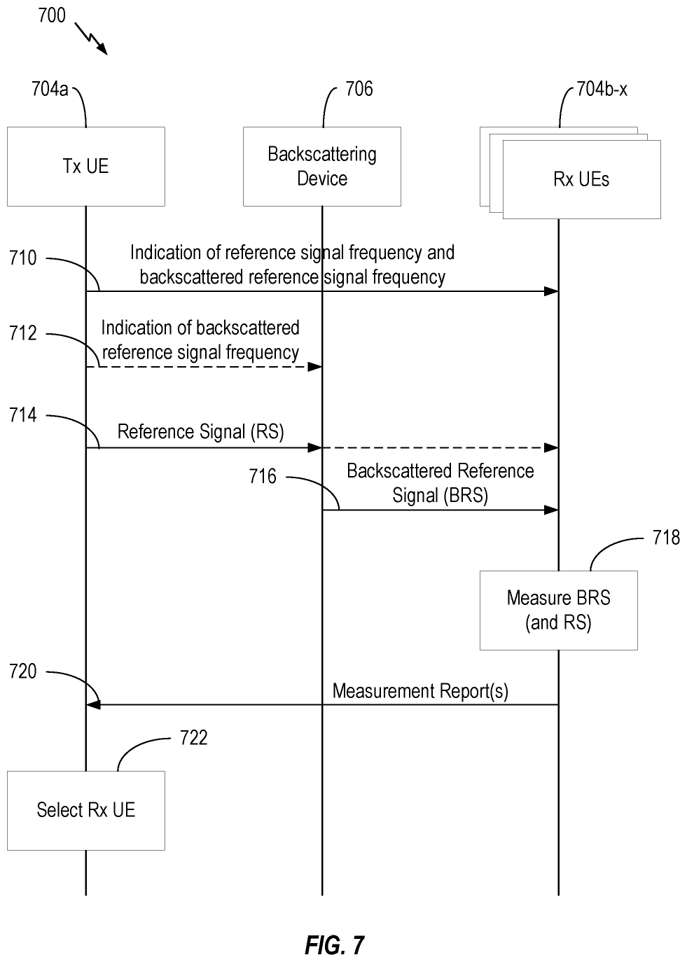

At 608, Tx UE 604a identifies a UE of one or more UEs to act as an Rx UE. In this example, Tx UE 604a identifies Rx UE 604b. The Tx UE 604a may utilize any suitable technique to identify an Rx UE. For example, the Tx UE 604a may randomly select an Rx UE. In another example, Tx UE 604a may send (e.g., broadcast), such as on sidelink resources according to a sidelink protocol, to one or more UEs proximate to Tx UE 604a, a reference signal (RS). In certain aspects, prior to sending the RS, the Tx UE 604a may send (e.g., broadcast), such as on sidelink resources according to the sidelink protocol, to the one or more UEs, control information (e.g., sidelink control information) indicating one or more communication resources (e.g., time-frequency resources) on which the RS is scheduled for transmission. Each of the one or more UEs may measure the RS to determine a respective indication of channel quality (e.g., channel quality indicator (CQI), reference signal received power (RSRP), reference signal received quality (RSRQ), and/or the like) between the Tx UE 604a and the respective UE. Each of the one or more UEs may send to the Tx UE 604a, such as on sidelink resources according to the sidelink protocol, its respective indication of channel quality, such as in a respective measurement report. The Tx UE 604a may identify one of the one or more UEs as the Rx UE 604b based on the indications of channel quality, such as by selecting a UE with a highest or best indication of channel quality among the one or more UEs. Another example of Rx UE selection is discussed further with respect to FIG. 7.

At 610, Tx UE 604a sends, such as on sidelink resources according to the sidelink protocol, to the Rx UE 604b identified at 608, an indication of a frequency of a signal (also referred to as an initial signal) the Tx UE 604a is to send to the backscattering device 606 and an indication of a frequency of a backscattered signal the backscattering device 606 is to send by modulating and reflecting the initial signal from the Tx UE 604a. In certain aspects, the indication of the frequency of the initial signal includes the actual frequency of the initial signal and the indication of the frequency of the backscattered signal includes the actual frequency of the backscattered signal. In some aspects, the indication of the frequency of the initial signal includes the actual frequency of the initial signal, while the indication of the frequency of the backscattered signal includes the frequency shift (or delta) between the initial signal and the backscattered signal. In certain aspects, the frequency of the initial signal is the same as the frequency of an RS used to identify Rx UE 604b. In certain aspects, the frequency of the initial signal is different than the frequency of an RS used to identify Rx UE 604b. Accordingly, when received, the Rx UE 604b can identify the initial signal and the backscattered signal based on the frequencies of the signals. In certain aspects, the frequency of the initial signal and the frequency of the backscattered signal are selected such that both frequencies correspond to sidelink resources (e.g., fall within frequency range(s)) used for communication between Tx UE 604a and Rx UE 604b, such as to avoid interference with other communications devices.

Optionally, at 612, Tx UE 604a sends, such as on sidelink resources, to the backscattering device 606, an indication of the frequency of the backscattered signal the backscattering device 606 is to send by modulating and reflecting the initial signal from the Tx UE 604a. In certain aspects, the indication of the frequency of the backscattered signal includes the actual frequency of the backscattered signal. In some aspects, the indication of the frequency of the backscattered signal includes the frequency shift the backscattering device is to apply to the initial signal. For example, in certain aspects, the frequency shift applied by backscattering device 606 may be configurable, such that Tx UE 604a indicates to backscattering device 606 which frequency shift to use. In some cases, the frequency shift applied by backscattering device 606 may not be configurable. For example, the backscattering device 606 may have a fixed frequency shift. Accordingly, Tx UE 604a may not perform 612.

At 614, Tx UE 604a transmits the initial signal to backscattering device 606. The initial signal may be a CW. The initial signal may be transmitted at the indicated frequency of the initial signal. In some cases, the Rx UE 604b may also receive the initial signal.

At 616, backscattering device 606 modulates and reflects the initial signal as a backscattered signal. For example, the backscattering device 606 modulates the initial signal to encode information (e.g., data, control information, etc.) on the backscattered signal. The backscattering device 606 may further apply a frequency shift to the initial signal, such that the backscattered signal occupies a different frequency than the initial signal. For example, the backscattered signal may occupy the indicated frequency of the backscattered signal. The Rx UE 604b receives the backscattered signal.

At 618, the Rx UE 604b decodes the received backscattered signal to obtain the information encoded on the backscattered signal. For example, Rx UE 604b demodulates the backscattered signal to obtain the information. In certain aspects, Rx UE 604b also receives the initial signal and separates the initial signal from the backscattered signal, so that it can then decode the backscattered signal. For example, Rx UE 604b applies a filter to a received signal including the initial signal and the backscattered signal, to obtain the backscattered signal.

At 620, the Rx UE 604b sends the information obtained from the backscattered signal to the Tx UE 604a, such as on sidelink resources according to the sidelink protocol. Accordingly, the Tx UE 604a can obtain the information encoded in the backscattered signal.

### Aspects Related to Backscattering Device Assisted Rx UE Identification

As discussed, certain aspects discussed herein provide techniques for a Tx UE to utilize a backscattering device to help identify a suitable UE to act as the Rx UE, which may improve communications reliability between the Rx UE and the backscattering device. An example of such a technique is discussed with respect to FIG. 7.

FIG. 7 depicts a process flow 700 for communications in a network between a Tx UE 704a, one or more (e.g., multiple) Rx UEs 704b-x, and a backscattering device 706 (such as an AIoT device). In some aspects, each of the Tx UE 704a and/or one or more Rx UEs 704b-x may be an example of UE 104 depicted and described with respect to FIGS. 1 and 3. However, in other aspects, each of the Tx UE 704a and/or one or more Rx UEs 704b-x may be another type of wireless communications device, such as those described herein. Backscattering device 706 may be an example of backscattering wireless communications device 506 depicted and described with respect to FIG. 5. However, in other aspects, backscattering device 706 may be another type of wireless communications device, such as those described herein.

At 710, Tx UE 704a sends (e.g., broadcasts), such as on sidelink resources according to a sidelink protocol, to the one or more Rx UEs 704b-x, an indication of a frequency of an RS the Tx UE 704a is to send (e.g., broadcast), including to the backscattering device 706, and an indication of a frequency of a backscattered RS the backscattering device 706 is to send by modulating and reflecting the RS from the Tx UE 704a. Tx UE 704a may send the indications as control information, (e.g., sidelink control information), such as indicating one or more communication resources (e.g., time-frequency resources) on which the RS and the backscattered RS are scheduled for transmission. The frequency of the RS may be the same or different than the frequency of the initial signal of 614. Where the frequency is the same, measurements of the RS may be more indicative of measurements of the initial signal. Further, the frequency of the backscattered RS may be the same or different than the frequency of the backscattered signal of 616. Where the frequency is the same, measurements of the backscattered RS may be more indicative of measurements of the backscattered signal.

In certain aspects, the indication of the frequency of the RS includes the actual frequency of the RS and the indication of the frequency of the backscattered RS includes the actual frequency of the backscattered RS. In some aspects, the indication of the frequency of the RS includes the actual frequency of the RS, while the indication of the frequency of the backscattered RS includes the frequency shift (or delta) between the RS and the backscattered RS. Accordingly, when received, the one or more Rx UEs 704b-x can identify the RS and the backscattered RS based on the frequencies of the signals. In certain aspects, the frequency of the RS and the frequency of the backscattered RS are selected such that both frequencies correspond to sidelink resources (e.g., fall within frequency range(s)) used for communication between Tx UE 704a and one or more Rx UEs 704b-x, such as to avoid interference with other communications devices.

Optionally, at 712, Tx UE 704a sends, such as on sidelink resources, to the backscattering device 706, an indication of the frequency of the backscattered RS the backscattering device 706 is to send by modulating and reflecting the RS from the Tx UE 704a. In certain aspects, the indication of the frequency of the backscattered RS includes the actual frequency of the backscattered RS. In some aspects, the indication of the frequency of the backscattered RS includes the frequency shift the backscattering device is to apply to the RS. For example, in certain aspects, the frequency shift applied by backscattering device 706 may be configurable, such that Tx UE 704a indicates to backscattering device 706 which frequency shift to use. In some cases, the frequency shift applied by backscattering device 706 may not be configurable. For example, the backscattering device 706 may have a fixed frequency shift. Accordingly, Tx UE 704a may not perform 712.

At 714, Tx UE 704a transmits the RS, including to backscattering device 706. The RS may be a CW. The RS may be transmitted at the indicated frequency of the RS. In some cases, the one or more Rx UEs 704b-x may also each receive the RS.

At 716, backscattering device 706 modulates and reflects the RS as a backscattered RS. The backscattering device 706 may further apply a frequency shift to the RS, such that the backscattered RS occupies a different frequency than the RS. For example, the backscattered RS may occupy the indicated frequency of the backscattered RS. The one or more Rx UEs 704b-x each receive the backscattered RS.

At 718, each of the one or more Rx UEs 704b-x may measure the backscattered RS to determine a respective indication of channel quality (also referred to as signal quality) between the backscattering device 706 and the respective Rx UE 704b-x. Further, in some cases, each of the one or more Rx UEs 704b-x may measure the RS to determine a respective indication of channel quality between the Tx UE 704a and the respective Rx UE 704b-x.

At 720, each of the one or more Rx UEs 704b-x may send to the Tx UE 704a, such as on sidelink resources according to the sidelink protocol, its respective indication of channel quality between the backscattering device 706 and the respective Rx UE 704b-x, such as in a respective measurement report. Further, in some cases, each of the one or more Rx UEs 704b-x may send to the Tx UE 704a, such as on sidelink resources according to the sidelink protocol, its respective indication of channel quality between the Tx UE 704a and the respective Rx UE 704b-x, such as in the respective measurement report.

At 722, the Tx UE 704a may identify/select one of the one or more Rx UEs 704b-x as the Rx UE to use for UE assisted relay of information from a backscattered signal based on the indications of channel quality received at 720.

For example, the Tx UE 704a may identify one of the one or more Rx UEs 704b-x as the Rx UE to use based on the indications of channel quality between the backscattering device 706 and the Rx UEs 704b-x. For example, the Tx UE 704a may select one of the one or more Rx UEs 704b-x with a suitable (e.g., highest among the Rx UEs 704b-x, above a threshold, etc.) indicated channel quality between the backscattering device 706 and the respective Rx UE 704b-x. This may help ensure adequate channel quality between the Rx UE selected and the backscattering device 706.

In certain aspects, the Tx UE 704a may identify one of the one or more Rx UEs 704b-x as the Rx UE to use based on 1) the indications of channel quality between the backscattering device 706 and the Rx UEs 704b-x; and 2) the indications of channel quality between the Tx UE 704a and the Rx UEs 704b-x. For example, for each of the one or more Rx UEs 704b-x, the Tx UE 704a may calculate a score (e.g., average, weighted average, etc.) based on the indicated channel quality between the backscattering device 706 and the respective Rx UE 704b-x and the indicated channel quality between the Tx UE 704a and the respective Rx UE 704b-x. In some aspects, such as where the score is a weighted average, a higher weight is used for the indicated channel quality between the backscattering device 706 and the respective Rx UE 704b-x as the backscattered RS likely has a lower signal strength than the RS, such that the RS may be more likely to be received properly. The Tx UE 704a may select one of the one or more Rx UEs 704b-x with a suitable (e.g., highest among the Rx UEs 704b-x, above a threshold, etc.) score. This may help ensure adequate channel quality between the Rx UE selected and each of the backscattering device 706 and the Tx UE 704a.

### Example Operations

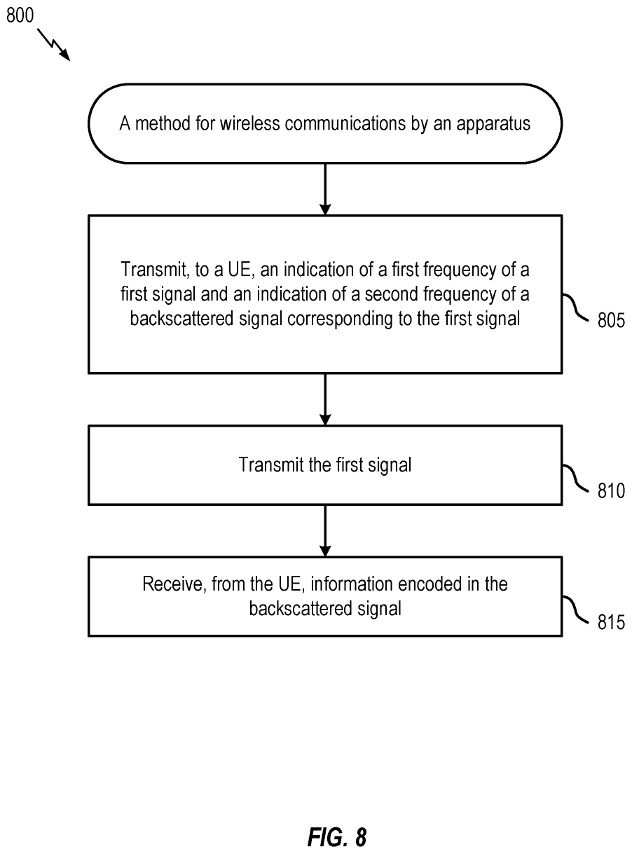

FIG. 8 shows a method 800 for wireless communications by an apparatus, such as UE 104 of FIGS. 1 and 3.

Method 800 begins at step 805 with transmitting, to a UE, an indication of a first frequency of a first signal and an indication of a second frequency of a backscattered signal corresponding to the first signal. For example, step 805 may correspond to 610 of FIG. 6.

Method 800 then proceeds to step 810 with transmitting the first signal. For example, step 810 may correspond to 614 of FIG. 6.

Method 800 then proceeds to step 815 with receiving, from the UE, information encoded in the backscattered signal. For example, step 815 may correspond to 620 of FIG. 6.

In certain aspects, the indication of the second frequency comprises an indication of a frequency shift relative to the first frequency.

In certain aspects, the first frequency and the second frequency correspond to sidelink resources for communication between the apparatus and the UE.

In certain aspects, method 800 further includes transmitting, to a device configured to generate the backscattered signal, an indication of a frequency shift between the first frequency and the second frequency.

In certain aspects, method 800 further includes transmitting an indication of a third frequency of a reference signal and an indication of a fourth frequency of a backscattered reference signal corresponding to the reference signal.

In certain aspects, method 800 further includes transmitting the reference signal.

In certain aspects, method 800 further includes receiving, from each of one or more UEs including the UE, an indication of signal quality of the backscattered reference signal at the respective UE.

In certain aspects, the third frequency is the same as the first frequency, and the fourth frequency is the same as the second frequency.

In certain aspects, method 800 further includes selecting the UE to transmit the information encoded in the backscattered signal to the apparatus based on the indication of signal quality of the backscattered reference signal at the UE.

In certain aspects, method 800 further includes receiving, from each of one or more UEs including the UE, an indication of signal quality of the reference signal at the respective UE.

In certain aspects, method 800 further includes selecting the UE to transmit the information encoded in the backscattered signal to the apparatus based on the indication of signal quality of the backscattered reference signal at the UE and the indication of signal quality of the reference signal at the UE.

In certain aspects, method 800 further includes transmitting, to a device configured to generate the backscattered reference signal and the backscattered signal, an indication of a frequency shift between the third frequency and the fourth frequency.

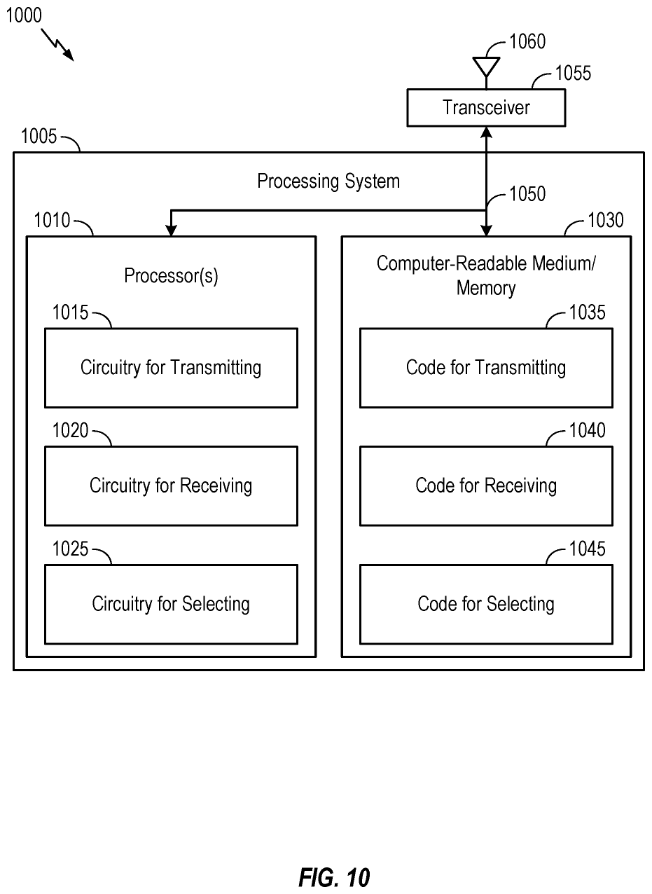

In certain aspects, method 800, or any aspect related to it, may be performed by an apparatus, such as communications device 1000 of FIG. 10, which includes various components operable, configured, or adapted to perform the method 800. Communications device 1000 is described below in further detail.

Note that FIG. 8 is just one example of a method, and other methods including fewer, additional, or alternative steps are possible consistent with this disclosure.

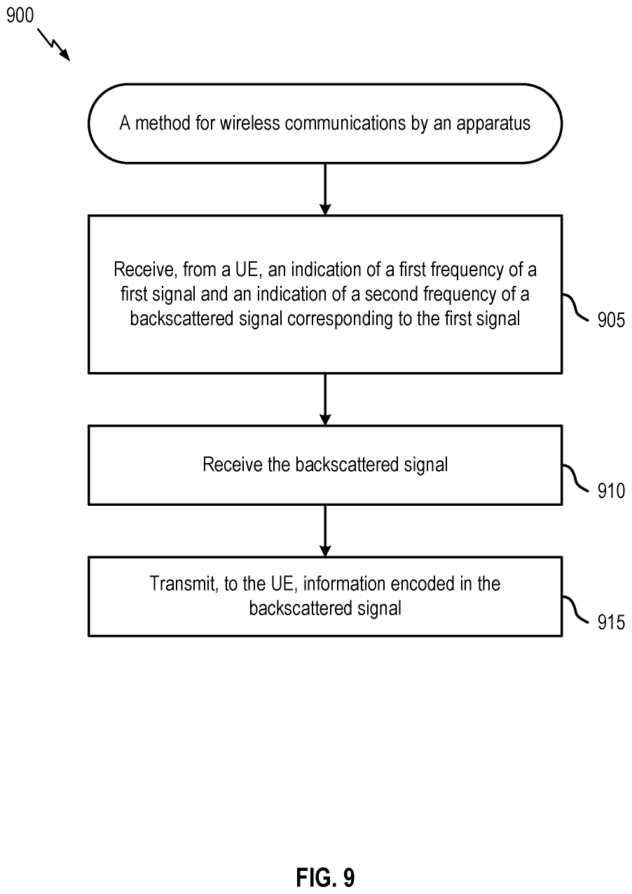

FIG. 9 shows a method 900 for wireless communications by an apparatus, such as UE 104 of FIGS. 1 and 3.

Method 900 begins at step 905 with receiving, from a UE, an indication of a first frequency of a first signal and an indication of a second frequency of a backscattered signal corresponding to the first signal. For example, step 905 may correspond to 610 of FIG. 6.

Method 900 then proceeds to step 910 with receiving the backscattered signal. For example, step 910 may correspond to 616 of FIG. 6.

Method 900 then proceeds to step 915 with transmitting, to the UE, information encoded in the backscattered signal. For example, step 915 may correspond to 620 of FIG. 6.

In certain aspects, the indication of the second frequency comprises an indication of a frequency shift relative to the first frequency.

In certain aspects, method 900 further includes receiving an indication of a third frequency of a reference signal and an indication of a fourth frequency of a backscattered reference signal corresponding to the reference signal.

In certain aspects, method 900 further includes receiving the backscattered reference signal.

In certain aspects, method 900 further includes transmitting, to the UE, an indication of signal quality of the backscattered reference signal at the apparatus.

In certain aspects, method 900 further includes receiving the reference signal.

In certain aspects, method 900 further includes transmitting, to the UE, an indication of signal quality of the reference signal at the apparatus.

In certain aspects, method 900 further includes receiving the first signal.

In certain aspects, method 900 further includes separating the first signal from the backscattered signal.

In certain aspects, method 900 further includes decoding the backscattered signal.

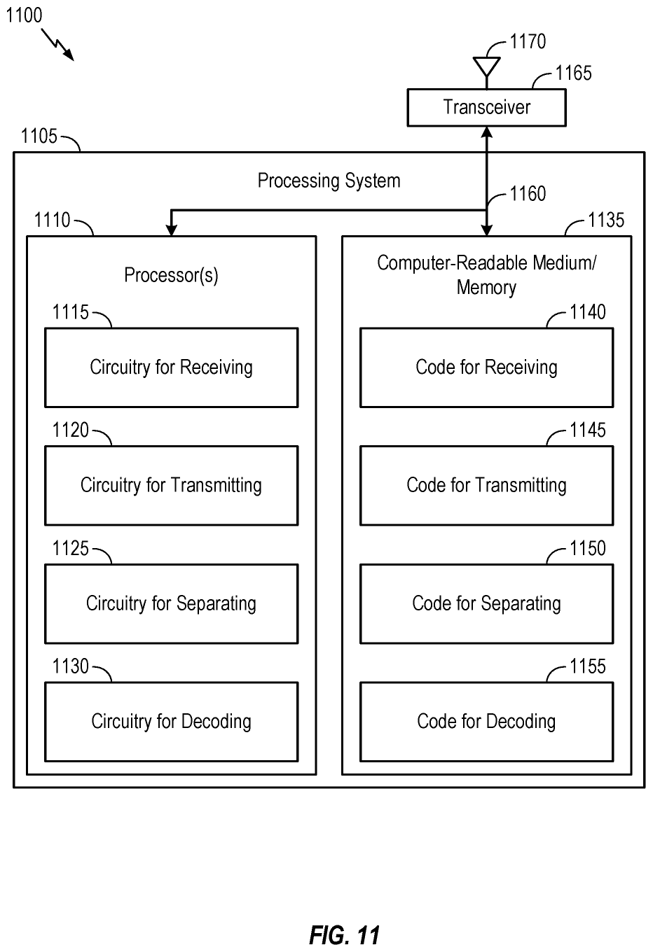

In certain aspects, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative steps are possible consistent with this disclosure.

### Example Communications Devices

FIG. 10 depicts aspects of an example communications device 1000. In some aspects, communications device 1000 is a user equipment, such as UE 104 described above with respect to FIGS. 1 and 3.

The communications device 1000 includes a processing system 1005 coupled to a transceiver 1055 (e.g., a transmitter and/or a receiver). The transceiver 1055 is configured to transmit and receive signals for the communications device 1000 via an antenna 1060, such as the various signals as described herein. The processing system 1005 may be configured to perform processing functions for the communications device 1000, including processing signals received and/or to be transmitted by the communications device 1000.

The processing system 1005 includes one or more processors 1010. In various aspects, the one or more processors 1010 may be representative of one or more of receive processor 358, transmit processor 364, TX MIMO processor 366, and/or controller/processor 380, as described with respect to FIG. 3. The one or more processors 1010 are coupled to a computer-readable medium/memory 1030 via a bus 1050. In certain aspects, the computer-readable medium/memory 1030 is configured to store instructions (e.g., computer-executable code) that when executed by the one or more processors 1010, enable and cause the one or more processors 1010 to perform the method 800 described with respect to FIG. 8, or any aspect related to it, including any additional steps or sub-steps described in relation to FIG. 8. Note that reference to a processor performing a function of communications device 1000 may include one or more processors performing that function of communications device 1000, such as in a distributed fashion.

In the depicted example, computer-readable medium/memory 1030 stores code for transmitting 1035, code for receiving 1040, and code for selecting 1045. Processing of the code 1035-1045 may enable and cause the communications device 1000 to perform the method 800 described with respect to FIG. 8, or any aspect related to it.

The one or more processors 1010 include circuitry configured to implement (e.g., execute) the code stored in the computer-readable medium/memory 1030, including circuitry for transmitting 1015, circuitry for receiving 1020, and circuitry for selecting 1025. Processing with circuitry 1015-1025 may enable and cause the communications device 1000 to perform the method 800 described with respect to FIG. 8, or any aspect related to it.

More generally, means for communicating, transmitting, sending or outputting for transmission may include the transceivers 354, antenna(s) 352, transmit processor 364, TX MIMO processor 366, and/or controller/processor 380 of the UE 104 illustrated in FIG. 3, transceiver 1055 and/or antenna 1060 of the communications device 1000 in FIG. 10, and/or one or more processors 1010 of the communications device 1000 in FIG. 10. Means for communicating, receiving or obtaining may include the transceivers 354, antenna(s) 352, receive processor 358, and/or controller/processor 380 of the UE 104 illustrated in FIG. 3, transceiver 1055 and/or antenna 1060 of the communications device 1000 in FIG. 10, and/or one or more processors 1010 of the communications device 1000 in FIG. 10.

FIG. 11 depicts aspects of an example communications device 1100. In some aspects, communications device 1100 is a user equipment, such as UE 104 described above with respect to FIGS. 1 and 3.

The communications device 1100 includes a processing system 1105 coupled to a transceiver 1165 (e.g., a transmitter and/or a receiver). The transceiver 1165 is configured to transmit and receive signals for the communications device 1100 via an antenna 1170, such as the various signals as described herein. The processing system 1105 may be configured to perform processing functions for the communications device 1100, including processing signals received and/or to be transmitted by the communications device 1100.

The processing system 1105 includes one or more processors 1110. In various aspects, the one or more processors 1110 may be representative of one or more of receive processor 358, transmit processor 364, TX MIMO processor 366, and/or controller/processor 380, as described with respect to FIG. 3. The one or more processors 1110 are coupled to a computer-readable medium/memory 1135 via a bus 1160. In certain aspects, the computer-readable medium/memory 1135 is configured to store instructions (e.g., computer-executable code) that when executed by the one or more processors 1110, enable and cause the one or more processors 1110 to perform the method 900 described with respect to FIG. 9, or any aspect related to it, including any additional steps or sub-steps described in relation to FIG. 9. Note that reference to a processor performing a function of communications device 1100 may include one or more processors performing that function of communications device 1100, such as in a distributed fashion.

In the depicted example, computer-readable medium/memory 1135 stores code for receiving 1140, code for transmitting 1145, code for separating 1150, and code for decoding 1155. Processing of the code 1140-1155 may enable and cause the communications device 1100 to perform the method 900 described with respect to FIG. 9, or any aspect related to it.

The one or more processors 1110 include circuitry configured to implement (e.g., execute) the code stored in the computer-readable medium/memory 1135, including circuitry for receiving 1115, circuitry for transmitting 1120, circuitry for separating 1125, and circuitry for decoding 1130. Processing with circuitry 1115-1130 may enable and cause the communications device 1100 to perform the method 900 described with respect to FIG. 9, or any aspect related to it.

More generally, means for communicating, transmitting, sending or outputting for transmission may include the transceivers 354, antenna(s) 352, transmit processor 364, TX MIMO processor 366, and/or controller/processor 380 of the UE 104 illustrated in FIG. 3, transceiver 1165 and/or antenna 1170 of the communications device 1100 in FIG. 11, and/or one or more processors 1110 of the communications device 1100 in FIG. 11. Means for communicating, receiving or obtaining may include the transceivers 354, antenna(s) 352, receive processor 358, and/or controller/processor 380 of the UE 104 illustrated in FIG. 3, transceiver 1165 and/or antenna 1170 of the communications device 1100 in FIG. 11, and/or one or more processors 1110 of the communications device 1100 in FIG. 11.

### Example Clauses

Implementation examples are described in the following numbered clauses:

Clause 1: A method for wireless communications by an apparatus, comprising: transmitting, to a UE, an indication of a first frequency of a first signal and an indication of a second frequency of a backscattered signal corresponding to the first signal; transmitting the first signal; and receiving, from the UE, information encoded in the backscattered signal.

Clause 2: The method of Clause 1, wherein the indication of the second frequency comprises an indication of a frequency shift relative to the first frequency.

Clause 3: The method of any one of Clauses 1-2, wherein the first frequency and the second frequency correspond to sidelink resources for communication between the apparatus and the UE.

Clause 4: The method of any one of Clauses 1-3, further comprising: transmitting, to a device configured to generate the backscattered signal, an indication of a frequency shift between the first frequency and the second frequency.

Clause 5: The method of any one of Clauses 1-4, further comprising: transmitting an indication of a third frequency of a reference signal and an indication of a fourth frequency of a backscattered reference signal corresponding to the reference signal; transmitting the reference signal; and receiving, from each of one or more UEs including the UE, an indication of signal quality of the backscattered reference signal at the respective UE.

Clause 6: The method of Clause 5, wherein the third frequency is the same as the first frequency, and the fourth frequency is the same as the second frequency.

Clause 7: The method of Clause 5, further comprising: selecting the UE to transmit the information encoded in the backscattered signal to the apparatus based on the indication of signal quality of the backscattered reference signal at the UE.

Clause 8: The method of Clause 5, further comprising: receiving, from each of one or more UEs including the UE, an indication of signal quality of the reference signal at the respective UE; and selecting the UE to transmit the information encoded in the backscattered signal to the apparatus based on the indication of signal quality of the backscattered reference signal at the UE and the indication of signal quality of the reference signal at the UE.

Clause 9: The method of Clause 5, further comprising: transmitting, to a device configured to generate the backscattered reference signal and the backscattered signal, an indication of a frequency shift between the third frequency and the fourth frequency.

Clause 10: A method for wireless communications by an apparatus, comprising: receiving, from a UE, an indication of a first frequency of a first signal and an indication of a second frequency of a backscattered signal corresponding to the first signal; receiving the backscattered signal; and transmitting, to the UE, information encoded in the backscattered signal.

Clause 11: The method of Clause 10, wherein the indication of the second frequency comprises an indication of a frequency shift relative to the first frequency.

Clause 12: The method of any one of Clauses 10-11, further comprising: receiving an indication of a third frequency of a reference signal and an indication of a fourth frequency of a backscattered reference signal corresponding to the reference signal; receiving the backscattered reference signal; and transmitting, to the UE, an indication of signal quality of the backscattered reference signal at the apparatus.

Clause 13: The method of Clause 12, further comprising: receiving the reference signal; and transmitting, to the UE, an indication of signal quality of the reference signal at the apparatus.

Clause 14: The method of any one of Clauses 10-13, further comprising: receiving the first signal; and separating the first signal from the backscattered signal.

Clause 15: The method of any one of Clauses 10-14, further comprising: decoding the backscattered signal.

Clause 16: One or more apparatuses, comprising: one or more memories (e.g., comprising executable instructions); and one or more processors configured to (e.g., execute the executable instructions and) cause the one or more apparatuses to perform a method in accordance with any one of clauses 1-15.

Clause 17: One or more apparatuses, comprising means for performing a method in accordance with any one of clauses 1-15.

Clause 18: One or more non-transitory computer-readable media comprising executable instructions that, when executed by one or more processors of one or more apparatuses, cause the one or more apparatuses to perform a method in accordance with any one of clauses 1-15.

Clause 19: One or more computer program products embodied on one or more computer-readable storage media comprising code for performing a method in accordance with any one of clauses 1-15.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
one or more memories; and
one or more processors configured to cause the apparatus to:
transmit, to a user equipment (UE), an indication of a first frequency of a first signal and an indication of a second frequency of a backscattered signal corresponding to the first signal;
transmit the first signal; and
receive, from the UE, information encoded in the backscattered signal.

2. The apparatus of claim 1, wherein the indication of the second frequency comprises an indication of a frequency shift relative to the first frequency.

3. The apparatus of claim 1, wherein the first frequency and the second frequency correspond to sidelink resources for communication between the apparatus and the UE.

4. The apparatus of claim 1, wherein the one or more processors are further configured to cause the apparatus to:
transmit, to a device configured to generate the backscattered signal, an indication of a frequency shift between the first frequency and the second frequency.

5. The apparatus of claim 1, wherein the one or more processors are further configured to cause the apparatus to:
transmit an indication of a third frequency of a reference signal and an indication of a fourth frequency of a backscattered reference signal corresponding to the reference signal;
transmit the reference signal; and
receive, from each of one or more UEs including the UE, an indication of signal quality of the backscattered reference signal at the respective UE.

6. The apparatus of claim 5, wherein the third frequency is the same as the first frequency, and the fourth frequency is the same as the second frequency.

7. The apparatus of claim 5, wherein the one or more processors are further configured to cause the apparatus to:
select the UE to transmit the information encoded in the backscattered signal to the apparatus based on the indication of signal quality of the backscattered reference signal at the UE.

8. The apparatus of claim 5, wherein the one or more processors are further configured to cause the apparatus to:
receive, from each of one or more UEs including the UE, an indication of signal quality of the reference signal at the respective UE; and
select the UE to transmit the information encoded in the backscattered signal to the apparatus based on the indication of signal quality of the backscattered reference signal at the UE and the indication of signal quality of the reference signal at the UE.

9. The apparatus of claim 5, wherein the one or more processors are further configured to cause the apparatus to:
transmit, to a device configured to generate the backscattered reference signal and the backscattered signal, an indication of a frequency shift between the third frequency and the fourth frequency.

10. An apparatus configured for wireless communications, comprising:
one or more memories; and
one or more processors configured to cause the apparatus to:
receive, from a user equipment (UE), an indication of a first frequency of a first signal and an indication of a second frequency of a backscattered signal corresponding to the first signal;
receive the backscattered signal; and
transmit, to the UE, information encoded in the backscattered signal.

11. The apparatus of claim 10, wherein the indication of the second frequency comprises an indication of a frequency shift relative to the first frequency.

12. The apparatus of claim 10, wherein the one or more processors are further configured to cause the apparatus to:
receive an indication of a third frequency of a reference signal and an indication of a fourth frequency of a backscattered reference signal corresponding to the reference signal;
receive the backscattered reference signal; and
transmit, to the UE, an indication of signal quality of the backscattered reference signal at the apparatus.

13. The apparatus of claim 12, wherein the one or more processors are further configured to cause the apparatus to:
receive the reference signal; and
transmit, to the UE, an indication of signal quality of the reference signal at the apparatus.

14. The apparatus of claim 10, wherein the one or more processors are further configured to cause the apparatus to:
receive the first signal; and
separate the first signal from the backscattered signal.

15. The apparatus of claim 10, wherein the one or more processors are further configured to cause the apparatus to:
decode the backscattered signal.

16. A method for wireless communications by an apparatus, comprising:
transmitting, to a user equipment (UE), an indication of a first frequency of a first signal and an indication of a second frequency of a backscattered signal corresponding to the first signal;
transmitting the first signal; and
receiving, from the UE, information encoded in the backscattered signal.

17. The method of claim 16, wherein the indication of the second frequency comprises an indication of a frequency shift relative to the first frequency.

18. The method of claim 16, wherein the first frequency and the second frequency correspond to sidelink resources for communication between the apparatus and the UE.

19. The method of claim 16, further comprising:
transmitting, to a device configured to generate the backscattered signal, an indication of a frequency shift between the first frequency and the second frequency.

20. The method of claim 16, further comprising:
transmitting an indication of a third frequency of a reference signal and an indication of a fourth frequency of a backscattered reference signal corresponding to the reference signal;
transmitting the reference signal; and
receiving, from each of one or more UEs including the UE, an indication of signal quality of the backscattered reference signal at the respective UE.
